(19) United States
(12) Patent Application Publication
(10) Pub. No.: US 2013/0202865 A1
(43) Pub. Date: Aug. 8, 2013

(54) ELECTROMAGNETIC SHIELDING COMPOSITE MATERIAL AND METHOD FOR MANUFACTURING THE SAME

(71) Applicants: Byung Sam Choi, Gunpo (KR); Kyong Hwa Song, Seoul (KR); Han Saem Lee, Ansan (KR); Jin Woo Kwak, Suwon (KR)

(72) Inventors: Byung Sam Choi, Gunpo (KR); Kyong Hwa Song, Seoul (KR); Han Saem Lee, Ansan (KR); Jin Woo Kwak, Suwon (KR)

(73) Assignee: Hyundai Motor Company, Seoul (KR)

(21) Appl. No.: 13/461,196

(22) Filed: May 1, 2012

(30) Foreign Application Priority Data
Feb. 7, 2012 (KR) 10-2012-0012550

(51) Int. Cl. B32B 9/04; B32B 5/16; B05D 5/12; B82Y 40/00; B82Y 30/00

(52) U.S. Cl. 428/216; 428/323; 428/213; 428/206; 427/122; 977/742; 977/750; 977/752; 977/890

(57) ABSTRACT

The disclosure provides an electromagnetic shielding composite material, and a method for manufacturing the same. The electromagnetic shielding composite material includes: a polymer sheet; and an acicular carbon nanotube layer including acicular portions of carbon nanotubes fixed on the polymer sheet. The method for manufacturing the electromagnetic shielding composite material includes: preparing a carbon nanotube dispersion solution; applying the carbon nanotube dispersion solution to the surface of a polymer sheet; and drying the polymer sheet to which the carbon nanotube dispersion solution is applied and then forming an acicular structure of carbon nanotubes on the polymer sheet. The composite material has superb electromagnetic wave shielding properties suitable for a variety of electronics applications.

### CROSS-REFERENCE TO RELATED APPLICATION

This application claims under 35 U.S.C. §119(a) the benefit of Korean Patent Application No. 10-2012-0012550 filed Feb. 7, 2012, the entire contents of which are incorporated herein by reference.

### BACKGROUND

(a) Technical Field

The present invention relates to an electromagnetic shielding composite material, and a method for manufacturing the same. More particularly, it relates to an electromagnetic shielding composite material comprising a polymer with an acicular carbon nanotube coating layer, and a method for manufacturing the same.

(b) Background Art

The rapid development and mass production of computers, electronic products, communication devices, etc., has had the effect of increasing the generation of electromagnetic waves. Additionally, the generation of noise due to electromagnetic waves in a wide frequency range has been also sharply increased, and has caused many problems such as, for example, interference between electronic products.

Such interference is of particular concern in vehicles, where electronic equipment is used in various safety devices for the safety of the driver and passengers. In this situation, a high reliability is required in terms of the prevention of electromagnetic interference between electronic components, the shielding of electromagnetic waves, and the immunity due to low power, high integration, and multifunction design of electronic components or circuits used in electronic equipment.

Conventionally, the best way to effectively prevent electromagnetic interference between electronic equipment is to cover the electronic equipment with a metal housing, or to configure an expensive electromagnetic shielding circuit. However, this methodology is disadvantageous because when an electronic product is covered with metal, it increases manufacturing costs due to, for example, the requirement for special equipment molds. Furthermore, it is also disadvantageous because it increases the weight of the electronic equipment, which has a negative impact on fuel efficiency of the vehicle due to the weight of the metal.

Accordingly, extensive research has been aimed at developing engineering polymer plastics to replace the use of metal as an electromagnetic shielding material. In order to engineer such polymer plastics (i.e., to impart electrical conductivity like a metal), the conventional art has used a composite material to which an electrically conductive filler has been added. However, the method is disadvantageous because it is necessary to employ extrusion and injection methods, which are typically used to synthesize the polymer, in the process of adding the conductive filler to the polymer. Consequently, it is very difficult to uniformly disperse and distribute the conductive filler in the polymer. Various methods such as surface treatment of the conductive filler, addition of a compatibilizer to increase the compatibility between the filler and the polymer, etc. have been proposed to overcome the difficulty of dispersion, however, none of these attempts have been successful, and the issues with the difficulty of dispersion has yet to be overcome.

The use of nanomaterials as electromagnetic shielding and absorbing fillers has been studied and, in particular, ferromagnetic metal particles such as iron, cobalt, nickel, etc., and conductive carbon nanomaterials such as carbon fiber, carbon nanotubes (CNT), graphite, graphene, etc., has been studied as candidates. Unfortunately, such metal particles tend to be concentrated in the polymer during melt extrusion and injection molding, and the carbon nanomaterials tend to aggregate as a result of the van der Waals forces between the nanoparticles.

In order to overcome the many difficulties of dispersion, different types of fillers have been added in order to improve the dispersibility; however, such fillers have not been successful in generating a uniform dispersion throughout the polymer during polymer melt. Moreover, if the content of the filler in the polymer is 10% or higher with respect to the total weight, then there is no significant advantage in terms of price competitiveness, and it is very difficult to obtain an acceptable electromagnetic shielding effect at the content of 10% or lower.

Carbon nanotubes are long tubular materials comprising carbon atoms and having a nanoscale diameter. Carbon nanotubes have an electrical conductivity 1,000 times that of copper, a strength and elastic modulus 100 times that of steel, and a high aspect ratio of diameter to length. Accordingly, a polymer composite material in which carbon nanotubes are dispersed in a polymer matrix has attracted much attention because it would be a material with a high strength relative to its weight, and could be used as a conductive material, an electromagnetic shielding material, etc. However, carbon nanotubes in the form of a fine powder are difficult to use in a variety of applications, and have to be combined with other materials in order to be effective and exhibit their beneficial properties.

Accordingly, there is a need in the art fore a method of uniformly dispersing carbon nanotubes in a polymer, which would facilitate the development of polymers with improved electromagnetic shielding performance.

### SUMMARY OF THE DISCLOSURE

The present invention provides an electromagnetic shielding composite material, which has excellent electromagnetic shielding performance while avoiding the problems typically encountered with the dispersibility of conventional art conductive fillers, and a method for manufacturing the same.

In one aspect, the present invention provides an electromagnetic shielding composite material comprising: a polymer sheet; and an acicular carbon nanotube layer including acicular portions of carbon nanotubes fixed on the polymer sheet.

In an exemplary embodiment, the acicular carbon nanotube layer may comprise: a support layer including carbon nanotubes attached to the polymer sheet and having a substantially planar shape; and an acicular layer including acicular portions of carbon nanotubes partially peeled off from the support layer and the polymer sheet, and fixedly supported by the support layer.

In another aspect, the present invention provides a method for manufacturing an electromagnetic shielding composite material, the method comprising: preparing a carbon nanotube dispersion solution; applying the carbon nanotube dispersion solution to the surface of a polymer sheet; and drying the polymer sheet to which the carbon nanotube dispersion solution is applied and then forming an acicular structure of carbon nanotubes on the polymer sheet, thus manufacturing a composite material in which an acicular carbon nanotube layer comprising acicular portions of the carbon nanotubes is fixed on the polymer sheet.

In an exemplary embodiment, an adhesive tape is attached to the polymer sheet to which the carbon nanotubes are fixed during the formation of the acicular structure of the carbon nanotubes, and then removed to partially peel the carbon nanotubes away from the polymer sheet, thus forming the acicular portions.

Other aspects and exemplary embodiments of the invention are discussed infra.

### BRIEF DESCRIPTION OF THE DRAWINGS

The above and other features of the present invention will now be described in detail with reference to certain exemplary embodiments thereof illustrated by the accompanying drawings, which are given hereinbelow by way of illustration only, and thus are not limitative of the present invention, and wherein:

FIG. 1 is a schematic cross-sectional view showing an electromagnetic shielding composite material in accordance with an exemplary embodiment of the present invention.

FIG. 2 is a schematic diagram showing a method for forming an acicular structure of carbon nanotubes on a polymer sheet in accordance with an exemplary embodiment of the present invention.

FIG. 3 is an SEM image of an acicular carbon nanotube layer in a composite material in accordance with an exemplary embodiment of the present invention.

FIG. 4 is a graph showing the results of an electromagnetic shielding performance test in an Example of the present invention and in a Comparative Example.

Reference numerals set forth in the Drawings include reference to the following elements as further discussed below:

| | |
|---|---|
| 10: electromagnetic shielding composite material | |
| 11: polymer sheet | |
| 12a: support layer | 12b: acicular layer |
| 12c: carbon nanotube dispersion solution | |

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter reference will now be made in detail to various embodiments of the present invention, examples of which are illustrated in the accompanying drawings and described below. While the invention will be described in conjunction with exemplary embodiments, it will be understood that the present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example both gasoline-powered and electric-powered vehicles.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Ranges provided herein are understood to be shorthand for all of the values within the range. For example, a range of 1 to 50 is understood to include any number, combination of numbers, or sub-range from the group consisting of 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50, as well as all intervening decimal values between the aforementioned integers such as, for example, 1.1, 1.2, 1.3, 1.4, 1.5, 1.6, 1.7, 1.8, and 1.9. With respect to sub-ranges, “nested sub-ranges” that extend from either end point of the range are specifically contemplated. For example, a nested sub-range of an exemplary range of 1 to 50 may comprise 1 to 10, 1 to 20, 1 to 30, and 1 to 40 in one direction, or 50 to 40, 50 to 30, 50 to 20, and 50 to 10 in the other direction.

The above and other features of the invention are discussed infra. According to an exemplary embodiment, the present invention provides an electromagnetic shielding composite material, which comprises a polymer sheet and a carbon nanotube layer comprising electrically conductive carbon nanomaterials such as, for example, carbon nanotubes, and a method for manufacturing the same. In particular, the present invention improves electromagnetic absorption and shielding performance by forming an acicular structure of carbon nanotubes on the surface of a polymer, instead of the conventional art method of dispersing a conductive filler in the polymer.

According to an exemplary embodiment of the invention, the composite material of the present invention has an electrical conductive layer that comprises acicular carbon nanotubes, which circumvent the problems encountered with trying to uniformly disperse a carbon nanotube filler in a polymer during a manufacturing process. The composite material provides effective electromagnetic wave absorption and shielding with the acicular structure of the conductive layer in which electromagnetic waves are absorbed and emitted, thus further improving the electromagnetic shielding performance in a high frequency range.

Carbon nanotubes are highly electrically conductive nanomaterials that have an aspect ratio of diameter to length of 1,000 or higher and, when the acicular structure of the carbon nanotubes is formed, it is possible to provide excellent electromagnetic wave shielding and absorption performance, especially when compared to the conventional art use of carbon nanotubes as a conductive filler in a polymer, or the use of a metal conductive shield. For example, the acicular structure of the carbon nanotubes according to an exemplary embodiment of the invention can induce electromagnetic waves like an antenna to be focused on a desired position or place. Moreover, when various types of nanoparticles are attached to the acicular structure, it is possible to readily absorb the induced electromagnetic waves. In such an exemplary embodiment, a support (e.g., a support layer as described below) of the acicular structure becomes a conductive layer to shield the induced electromagnetic waves and to allow the electromagnetic waves to be directed in a desired direction, or to destructively interfere with each other by shield reflection, thus further improving the shielding effect.

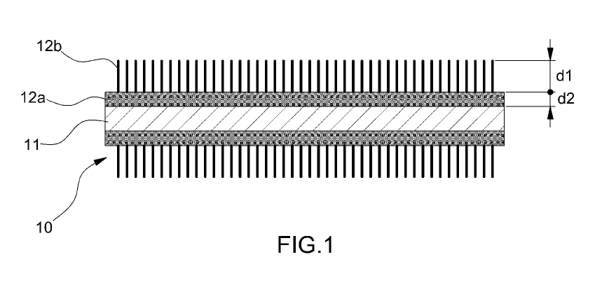

FIG. 1 is a schematic cross-sectional view showing an electromagnetic shielding composite material in accordance with an exemplary embodiment of the present invention. As shown in FIG. 1, a composite material 10 of the present invention comprises a polymer sheet 11 and an acicular carbon nanotube layer 12 comprising acicular portions of carbon nanotubes fixed on the polymer sheet 11. The acicular carbon nanotube layer 12 may be formed on one or both sides of the surface of the polymer sheet 11, and the acicular carbon nanotube layer 12 formed on each side comprises a support layer 12a and an acicular layer 12b. According to the composite material 10 of an exemplary embodiment of the present invention, the acicular carbon nanotube layer 12 fixed on the polymer sheet 11 comprises the support layer 12a, which includes carbon nanotubes attached to the surface of the polymer sheet 11 and has a substantially planar shape, and the acicular layer 12b, which includes acicular portions of carbon nanotubes partially peeled off from the support layer 12a and the polymer sheet 11 and is fixedly supported by the support layer 12a.

The support layer 12a comprises carbon nanotubes, which are arranged substantially in parallel to the surface of the polymer sheet 11 and fixed thereto. Additionally, support layer 12a comprises fixed carbon nanotubes, at least a portion of which form the acicular structure. The support layer 12a forms a layer of a predetermined thickness on the surface of the polymer sheet 11, which serves to support the acicular structure (e.g., the acicular layer) and also becomes a conductive layer as it comprises carbon nanotubes. The acicular layer 12b comprises the carbon nanotubes that have been peeled off from the support layer 12a and the polymer sheet 11, e.g., the acicular portions of the nanotubes. At least a portion of each carbon nanotube having the acicular portion forms the support 12a and is fixed on the polymer sheet 11.

The carbon nanotubes used in the present invention may include at least one selected from the group consisting of single-wall carbon nanotubes (SWNT), dual-wall carbon nanotubes (DWNT), and multi-wall carbon nanotubes (MWNT).

According to a preferred embodiment of the invention, the acicular carbon nanotube layer 12 comprising the support layer 12a and the acicular layer 12b has a thickness d2 of at least 1/10 that of thickness d1 of the support layer 12a. According to a preferred embodiment, it is preferable that the thickness d1 of the support layer 12a ranges from 5 to to 100 μm and that the thickness d2 of the acicular layer 12b ranges from 0.1 to 10 μm. If the thickness d2 of the acicular layer 12b is smaller than 0.1 μm, the role of the acicular structure may be reduced by the support layer 12a fixed on the polymer sheet 11, whereas, if the thickness d2 of the acicular layer 12b is greater than 10 μm, it is very difficult to maintain the acicular structure after manufacturing. Moreover, if the thickness d1 of the support layer 12a is smaller than 5 μm, the support layer 12a may be easily peeled off from the polymer sheet 11 during the process of forming the acicular layer 12b, i.e., during a process of partially peeling the carbon nanotubes to form the acicular structure (e.g., with the use of an adhesive tape), due to the very small thickness. On the other hand, if the thickness d1 of the support layer 12a exceeds 100 μm, the thickness d2 of the acicular layer 12b becomes smaller than 1/10 that d1 of the support layer 12a, and thus the beneficial properties of the acicular structure will be reduced or eliminated.

In particular, since the wavelength of the frequency is short in the shielding of electromagnetic waves over a wide high-frequency range, the increase in the thickness ratio of the acicular layer 12b to the support layer 12a can increase the induction of electromagnetic waves, thus improving the shielding and absorbing performance. Moreover, it is necessary to minimize the distance between adjacent acicular portions of the carbon nanotubes in order to facilitate the induction of electromagnetic waves by the acicular structure of the carbon nanotubes; however, it is preferable that the distance between the adjacent acicular portions is maintained at 10 to 500 nm in terms of the van der Waals forces between the carbon nanotubes. If the distance between the adjacent acicular portions is to greater than 500 nm, it is very difficult to achieve a desirable level of electromagnetic wave shielding performance.

According to an exemplary embodiment, the polymer sheet 11 used in the composite material 10 of the present invention may comprise at least one selected from the group consisting of polyamide, polycarbonate, polymethylmethacrylate, acrylonitrile-butadiene-styrene, polyethylene, polyethylene terephthalate, polypropylene, polyvinylchloride, polystyrene, polybutyl terephthalate, and styrene-acrylonitrile. Moreover, the polymer sheet 11 used in the present invention may include a polymer sheet in which a conventional conductive filler is dispersed in a polymer.

The configuration of the composite material 10 in which the acicular carbon nanotube layer 12 is formed on the surface of the polymer sheet 11 has been described. The composite material of the present invention can be used to manufacture an electromagnetic shielding housing for an electronic device, unit, or component and exhibit excellent shielding and absorbing performance as an electromagnetic shielding material.

Moreover, since the acicular carbon nanotube layer 12 may be formed on both sides of the polymer sheet 11, the acicular carbon nanotube layer 12 can be provided both inside and outside of the manufactured housing and, in this case, it is possible to effectively shield and absorb electromagnetic waves applied to the outside of the housing. Furthermore, during the formation of a polymer housing with angular surfaces, bending elongation does not occur at the bent portion of the housing, and a corresponding reduction in surface resistance due to non-uniformity of the electromagnetic shielding filler in the polymer does not occur. Therefore, a polymer housing formed according to an exemplary embodiment of the invention can be used for electromagnetic shielding application with respect to a highly integrated circuit.

Next, a method for manufacturing the above-described composite material will be described in detail with reference to the accompanying drawings.

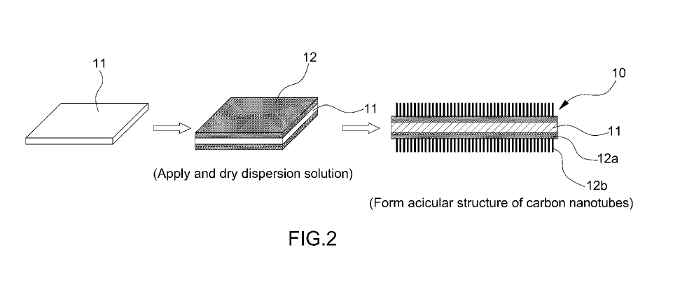

FIG. 2 is a schematic diagram showing a method for forming an acicular structure of carbon nanotubes on a polymer sheet 11 according to the present invention. The method for forming an acicular structure of carbon nanotubes on the polymer sheet 11 comprises a process of preparing a carbon nanotube dispersion solution 12c, a process of applying the carbon nanotube dispersion solution 12c to the surface of the polymer sheet 11, and a process of drying the polymer sheet 11 to which the carbon nanotube dispersion solution 12c is applied, and then forming an acicular structure of carbon nanotubes on the polymer sheet 11, thus manufacturing the composite material 10 in which the acicular carbon nanotube layer 12 is formed on the surface of the polymer sheet 11.

The process of preparing the dispersion solution comprises a pretreatment process of unraveling twisted strands of carbon nanotubes to impart a desired length to the carbon nanotubes. In the pretreatment process, the carbon nanotubes are mixed with the dispersion solution and dispersed using an ultrasonic homogenizer, and the resulting carbon nanotubes are filtered using a Teflon filter and then dried. When the carbon nanotubes are dispersed using an ultrasonic homogenizer, it is possible to adjust the length of the carbon nanotubes to an appropriate length.

After the pretreatment process, the dried carbon nanotubes are uniformly dispersed in a dispersion liquid to prepare a final dispersion solution. In order to improve the adhesion between the surface of the polymer sheet 11 and the carbon nanotubes in the process of applying the dispersion solution 12c to the surface of the polymer sheet 11, separate organic and inorganic binders are added to the dispersion solution during preparation. According to an exemplary embodiment of the invention, the binders may comprise acryl, urethane, acryl-urethane, glass frit, silane, and the like.

After preparing the carbon nanotube dispersion solution 12c in the above manner, the dispersion solution 12c may be uniformly applied to the surface of the polymer sheet 11 by soaking. Then, the polymer sheet 11 to which the dispersion solution 12c is applied is dried, and an acicular structure of carbon nanotubes on the polymer sheet 11 is formed in such a manner that a high-strength adhesive tape (e.g., an adhesive tape with an adhesive force of 50 g/25 mm or higher) is placed on the surface of the polymer sheet 11 to which the carbon nanotubes are attached, and then removed. According to an exemplary embodiment, the adhesive tape placed on the surface of the polymer sheet 11 is removed within a predetermined time (e.g., within 60 seconds) to form the acicular structure of the carbon nanotubes. At the moment when the adhesive tape is removed, the carbon nanotubes are partially peeled off from the surface of the polymer sheet 11 and the surface of the support layer 12a, thus forming the acicular structure of the carbon nanotubes, i.e., the above-described acicular layer 12b.

According to the above-described manufacturing method, it is possible to form a semi-permanent structure in which the acicular carbon nanotube layer 12 forming an electromagnetic shielding conductive layer is fixed on the surface of the polymer sheet 11.

Next, the present invention will be described in more detail with reference to the following Example, but the present invention is not limited by the following Examples.

### EXAMPLE

1. Preparation of Carbon Nanotube Dispersion Solution

100 g of multi-wall carbon nanotubes and 500 mL of methanol were mixed and dispersed using an ultrasonic homogenizer for 10 minutes. The resulting multi-wall carbon nanotubes were filtered using a Teflon filter and then dried in an oven at 100° C. for 24 hours. 100 g of the dried multi-wall carbon nanotubes and 100 g of terpineol were placed in a mortar and uniformly mixed. 20 mL of ethanol and 20 mL of acryl-urethane as a binder were added to the mixed carbon nanotubes-terpineol dispersion solution, and the resulting mixture was placed in a mortar and uniformly mixed again. 5 g of glass frit and 1 mL of ethoxy silane were added to the resulting dispersion solution, thus preparing a carbon nanotube dispersion solution having a viscosity of 1,000 cps or higher using a 3-roll mill

2. Application of Carbon Nanotube Solution on Polymer Sheet

A polypropylene polymer sheet was soaked in the prepared carbon nanotube dispersion solution for 10 seconds, and the resulting polymer sheet was pulled vertically upward such that the carbon nanotube dispersion solution ran down, and the polymer sheet to which the carbon nanotube dispersion solution was applied was placed vertically in an oven at 200° C. and dried for 2 hours.

3. Formation of Carbon Nanotube Acicular Structure Composite Material

A highly adhesive tape with an adhesive force of 50 g/25 mm or higher was placed on the surface of the polymer sheet on which the carbon nanotube dispersion solution was dried, and the adhesive tape was pulled at an angle of 90° with respect to the polymer sheet, thus forming an acicular structure of carbon nanotubes on the surface of the polymer sheet.

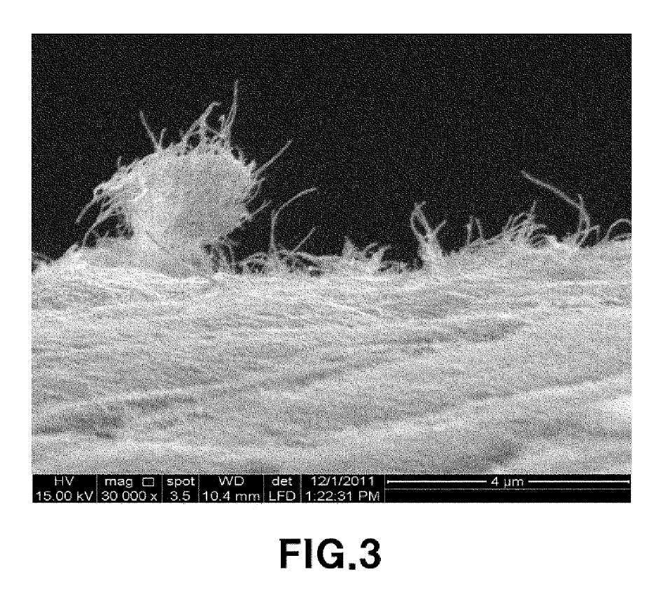

FIG. 3 is a scanning electron microscope (SEM) image of a final acicular carbon nanotube layer, which comprises a support layer formed on the surface of the polymer sheet and having a stacked structure with a substantially planar shape and acicular carbon nanotubes partially peeled off from the support layer.

In order to identify the electromagnetic shielding performance of the composite material manufactured according to the above-described Example, the amount of electromagnetic waves that were not transmitted through the composite sheet of the Example at 1 GHz, was measured using an Agilent E8362B analyzer.

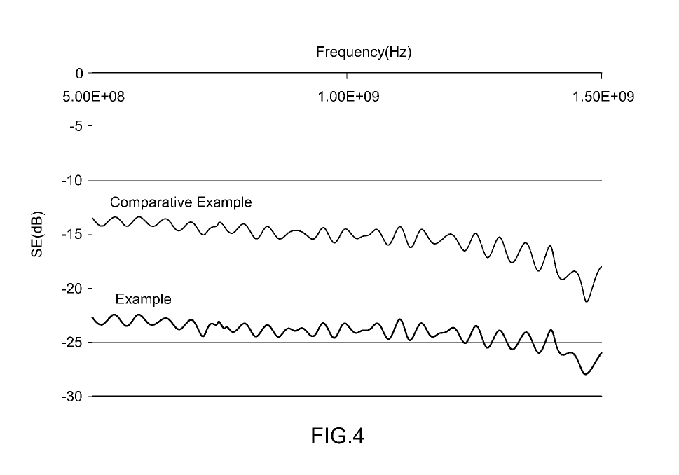

FIG. 4 is a graph showing the results of electromagnetic shielding performance test in an Example of the present invention and in a Comparative Example.

As shown in FIG. 4, the composite sheet having the acicular carbon nanotube layer according to the Example exhibited 23 dB, while the conventional polymer sheet using the same carbon nanotubes as a conductive filler according to the Comparative Example exhibited 15 dB. Thus, the composite sheet of the Example exhibited a shielding rate 1.6 times higher than the conventional polymer sheet.

As described above, according to the electromagnetic shielding composite material and the method for manufacturing the same, it is possible to provide an electromagnetic shielding material with improved electromagnetic absorbing and shielding performance by forming an acicular structure of carbon nanotubes on the surface of the polymer sheet.

In particular, according to the composite material of the present invention, the conductive layer in which electromagnetic waves are absorbed and emitted having an acicular structure can effectively induce and shield the flow of electromagnetic waves, thus further improving the electromagnetic shielding performance in a high frequency range.

The invention has been described in detail with reference to exemplary embodiments thereof. However, it will be appreciated by those skilled in the art that changes may be made in these embodiments without departing from the principles and spirit of the invention, the scope of which is defined in the appended claims and their equivalents.

What is claimed is:

1. An electromagnetic shielding composite material, comprising:
a polymer sheet; and
at least one carbon nanotube layer fixed on the polymer sheet, wherein the carbon nanotube layer comprises acicular carbon nanotubes.

2. The composite material of claim 1, wherein the at least one carbon nanotube layer is formed on both sides of the polymer sheet.

3. The composite material of claim 1, wherein the carbon nanotubes comprise at least one carbon nanotube selected form the group consisting of single-wall carbon nanotubes (SWNT), dual-wall carbon nanotubes (DWNT), multi-wall carbon nanotubes (MWNT), and any combination thereof.

4. The composite material of claim 1, wherein the polymer sheet comprises at least one polymer selected from the group consisting of polyamide, polycarbonate, polymethylmethacrylate, acrylonitrile-butadiene-styrene, polyethylene, polyethylene terephthalate, polypropylene, polyvinylchloride, polystyrene, polybutyl terephthalate, styrene-acrylonitrile, and any combination thereof.

5. The composite material of claim 1, wherein the carbon nanotube layer comprises:
a support layer including carbon nanotubes attached to the polymer sheet and having a substantially planar shape; and
an acicular layer including acicular portions of carbon nanotubes partially peeled off from the support layer and fixedly supported by the support layer.

6. The composite material of claim 5, wherein an acicular layer thickness is at least 1/10 that of a support layer thickness.

7. The composite material of claim 5, wherein the support layer thickness ranges from 5 to 100 μm and the acicular layer thickness ranges from 0.1 to 10 μm.

8. The composite material of claim 6, wherein the support layer thickness ranges from 5 to 100 μm and the acicular layer thickness ranges from 0.1 to 10 μm.

9. The composite material of claim 1, wherein adjacent acicular portions of the carbon nanotubes are separated by an adjacent acicular distance ranging from 10 to 500 nm.

10. A method for manufacturing an electromagnetic shielding composite material comprising:
preparing a carbon nanotube dispersion solution;
applying the carbon nanotube dispersion solution to at least one surface of a polymer sheet;
drying the polymer sheet to form a carbon nanotube support layer [please confirm] on the polymer sheet; and
forming acicular carbon nanotube portions in the carbon nanotube support layer to form the composite material.

11. The method of claim 10, further comprising:
placing an adhesive tape on the polymer sheet for a period of time; and
removing the adhesive tape to form the acicular portions.

12. The method of claim 10, wherein the acicular carbon nanotube portions are formed on one or both sides of the polymer sheet.

13. The method of claim 10, wherein the carbon nanotubes comprise at least one carbon nanotube selected form the group consisting of single-wall carbon nanotubes (SWNT), dual-wall carbon nanotubes (DWNT), multi-wall carbon nanotubes (MWNT), and any combination thereof.

14. The method of claim 10, wherein the polymer sheet comprises at least one polymer selected from the group consisting of polyamide, polycarbonate, polymethylmethacrylate, acrylonitrile-butadiene-styrene, polyethylene, polyethylene terephthalate, polypropylene, polyvinylchloride, polystyrene, polybutyl terephthalate, styrene-acrylonitrile, and any combination thereof.

15. The method of claim 10, wherein the carbon nanotube dispersion solution is prepared using carbon nanotubes, a dispersion liquid, and a binder, wherein the binder comprises acryl, urethane, acryl-urethane, glass frit, or silane.

16. The method of claim 11, wherein the time is about one minute.

17. The method of claim 10, wherein the acicular carbon nanotube portions are spaced by a distance ranging from 10 to 500 nm.

18. The method of claim 10, wherein the carbon nanotube support layer thickness ranges from 5 to 100 μm.

19. The method of claim 10, wherein the thickness of the acicular carbon nanotube portions ranges from 0.1 to 10 μm.
